(19) United States
(12) Patent Application Publication
(10) Pub. No.: US 2024/0385139 A1
(43) Pub. Date: Nov. 21, 2024

(54) PROGRAMMABLE SENSOR

(71) Applicant: Cypress Semiconductor Corporation, San Jose, CA (US)

(72) Inventors: Eashwar Thiagarajan, Bothell, WA (US); Ding Ma, Kirkland, WA (US); Nidhin Mulangattil Sudhakaran, Lynnwood, WA (US); Andrew Page, Kirkland, WA (US); Bert Sullam, Bellevue, WA (US)

(73) Assignee: Cypress Semiconductor Corporation, San Jose, CA (US)

(21) Appl. No.: 18/320,022

(22) Filed: May 18, 2023

(51) Int. Cl. G01N 27/403; G01N 27/416

(52) U.S. Cl. CPC G01N 27/403; G01N 27/416

(57) ABSTRACT

One or more computing devices, systems, and/or methods are provided. In an example of the techniques presented herein, a method is provided. The method includes connecting a first programmable electrode interface to one of a first working electrode, a control electrode, a reference electrode, or a guard electrode of an electrochemical cell in a first configuration, and connecting the first programmable electrode interface to a different one of the first working electrode, the control electrode, the reference electrode, or the guard electrode in a second configuration.

### BACKGROUND

Analyte sensing devices use electrodes in an electrochemical sensor to measure properties of a sample. A working electrode or a reference electrode may have an adjacent guard electrode or guard ring on which a signal is applied by a digital to analog converter (DAC) to establish an electric field around the sensing electrode. Providing enhanced sensing capability for an analyte sensing device requires additional electrodes, amplifiers, guard electrode drivers, and DACs, thereby increasing footprint and cost.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In an embodiment of the techniques presented herein, a sensor is provided. The sensor comprises an electrochemical cell comprising a first working electrode, a second working electrode, and a first guard electrode adjacent the first working electrode, and a programmable analog subsystem. The programmable analog subsystem comprises a first programmable electrode interface, and a second programmable electrode interface, wherein in a first configuration, the first programmable electrode interface is connected to the first working electrode and the second programmable electrode interface is connected to one of the first programmable electrode interface or the second working electrode, and in a second configuration, the first programmable electrode interface is connected to the first working electrode and the second programmable electrode interface is connected to the first guard electrode.

In an embodiment of the techniques presented herein, a sensor is provided. The sensor comprises an electrochemical cell comprising a first working electrode, a control electrode, a reference electrode, and a guard electrode adjacent one of the first working electrode or the guard electrode, and a programmable analog subsystem. The programmable analog subsystem comprises a first programmable electrode interface, and a controller configured to connect the first programmable electrode interface to one of the first working electrode, the control electrode, the reference electrode, or the guard electrode in a first configuration and to connect the first programmable electrode interface to a different one of the first working electrode, the control electrode, the reference electrode, or the guard electrode in a second configuration.

In an embodiment of the techniques presented herein, a system is provided. The system comprises means for connecting a first programmable electrode interface to one of a first working electrode, a control electrode, a reference electrode, or a guard electrode of an electrochemical cell in a first configuration, and means for connecting the first programmable electrode interface to a different one of the first working electrode, the control electrode, the reference electrode, or the guard electrode in a second configuration.

In an embodiment of the techniques presented herein, a method is provided. The method comprises connecting a first programmable electrode interface to one of a first working electrode, a control electrode, a reference electrode, or a guard electrode of an electrochemical cell in a first configuration, and connecting the first programmable electrode interface to a different one of the first working electrode, the control electrode, the reference electrode, or the guard electrode in a second configuration.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a diagram of a sensor system, in accordance with some embodiments.

FIG. 2 is a diagram of a programmable electrode interface, in

accordance with some embodiments.

FIGS. 3-8 are diagrams of configurations for programmable electrode interfaces, in accordance with some embodiments.

FIGS. 9-11 are diagrams of sensor arrangements with programmable electrode interfaces, in accordance with some embodiments.

FIG. 12 is a flow chart illustrating an example method for configuring a programmable electrode interface, in accordance with some embodiments.

FIG. 13 illustrates an exemplary embodiment of a computer-readable medium, in accordance with some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

It is to be understood that the following description of embodiments is not to be taken in a limiting sense. The scope of the present disclosure is not intended to be limited by the embodiments described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art.

All numerical values within the detailed description and the claims herein are modified by “about” or “approximately” the indicated value, and take into account experimental error and variations that would be expected by a person having ordinary skill in the art.

An analyte sensing system may include an electrochemical cell with working electrodes, a control electrode, and a reference electrode. Some of the electrodes may have guard electrodes, typically formed as a ring electrode surrounding the working or reference electrode. The analyte sensing system may include digital components, such as a central processing unit (CPU), a digital to analog converter (DAC), or a post processor, and analog components, such as amplifiers, that function as potentiostats, filters, drivers, and/or sensing elements. According to embodiments, described herein, analog electrode interfaces including amplifiers may be provided as reconfigurable electrode interfaces, that have configurable inputs, outputs, and resistor-networks that may be programmed to change the operating mode of the analyte sensing system to meet demands for multitask processing and facilitate power management. To improve power management performance, the electrode interfaces may be reconfigurable autonomously independent of the CPU, which may remain in a sleep mode or may perform a different operation. The CPU may be located in the same die/substrate as the analog circuits, or may be implemented separately.

Modern computing devices, especially automotive, wearable, hand-held, metering, appliance-integrated, and the like, require increasingly efficient power management. Many portable devices provide significant computational resources into small form factors. Compact dimensions may limit the capacity of portable devices for energy storage. Accordingly, managing energy consumption during execution of various tasks becomes increasingly important. Generally, executing a task faster using fewer components leads to better utilization of energy resources.

In some embodiments, programmable electrode interfaces may be combined into a programmable analog subsystem (PASS) that may be used in combination with or, in some implementations, separately from a CPU and a memory device. The CPU may have a variety of forms, such as a general purpose processor, an application processing unit (APU), a microcontroller unit (MCU), or some other processing resource programmable to perform specific operations. The CPU may be a separate circuit or a circuit embedded into a larger system. The PASS may comprise an autonomous controller independent of the CPU for decision-making regarding reconfiguring one or more electrode interfaces, programmable references and/or programmable comparators for use by the electrode interfaces, analog-to-digital converter (ADC) units, digital-to-analog converter (DAC) units, and/or post processing units. Based on a value of an input received by the PASS, the autonomous controller may reconfigure one or more of the programmable electrode interfaces to change the operating mode of the electrode interface and that of the analyte sensing system. The PASS may perform such reconfiguration without waking up the CPU, if the CPU is in a sleep state, or without requesting a CPU interrupt, if the CPU is in an active state. Independent reconfiguration of the PASS may allow the CPU to perform other functions, such as processing of digital tasks that may be related or unrelated to the tasks that the PASS is performing. This arrangement may allow processing the same task faster if both the PASS and the CPU are processing different parts of the same task, or it may allow concurrent processing of different tasks by the LP PASS and the CPU.

In some embodiments, a programmable electrode interface comprises one or operational amplifiers. Routing circuitry, such as multiplexers, allow the inputs to the operational amplifier to be configured, and also allow other operational amplifiers, digital-to-analog converter (DAC), programmable references, different electrodes, such as a control electrode, a reference electrode, a working electrode, or a guard electrode, and/or sensors, such as a temperature sensor or a microphone, to be connected to input or output terminals of the operational amplifier. Routing circuitry also allows the output of an operation amplifier in the programmable electrode interface to be routed to different components, such as another programmable electrode interface, an analog-to-digital converter (ADC), an output terminal, a comparator, or some other destination.

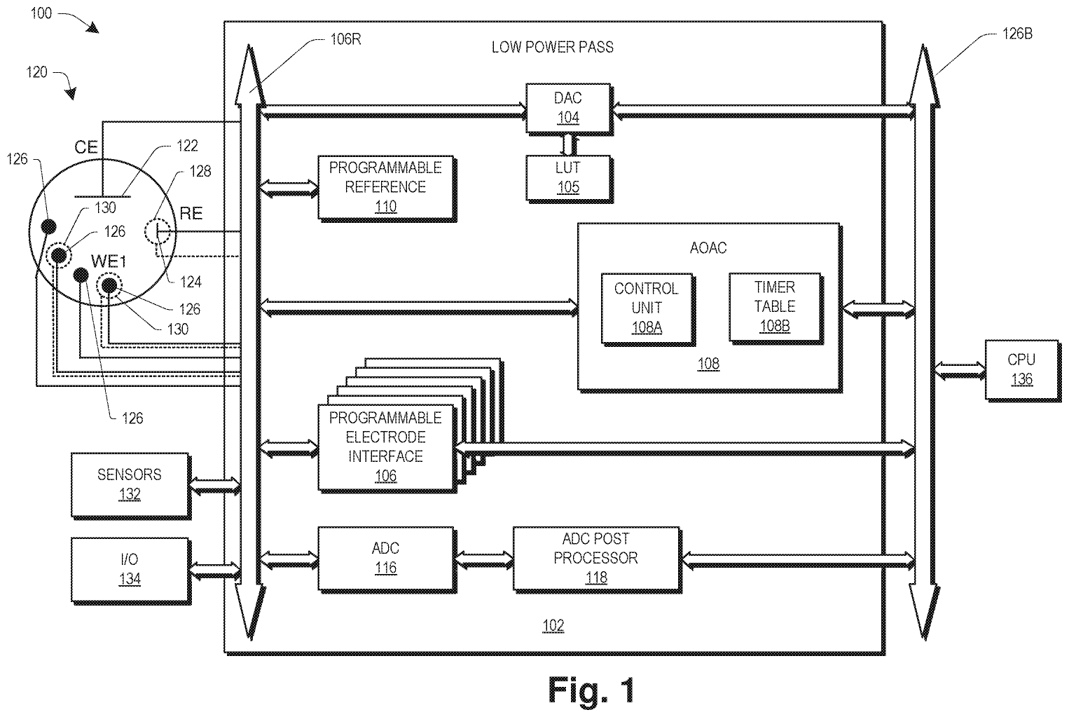

FIG. 1 is a diagram of system 100 comprising a programmable analog subsystem (PASS) 102, in accordance with some embodiments. In some embodiments, the PASS 102 comprises a DAC 104, programmable electrode interfaces 106, an always-on autonomous controller (AOAC) 108, a programmable reference unit 110, an ADC 116, and an ADC post processor 118. In some embodiments, the AOAC 108 comprises a control unit 108A and a timer table 108B. The timer table 108B stores configuration data for configuring the programmable electrode interfaces 106 into various operating modes. The control unit 108A, based on inputs to the PASS 102, selects configurations from the timer table 108B for dynamically configuring the programmable electrode interfaces 106. Routing circuitry 106R allows different input signals to be provided to the programmable electrode interfaces 106, the programmable comparator unit 112, and/or the ADC 116. Responsive to the input signal, the AOAC 108 may reconfigure one or more of the programmable electrode interfaces 106 so that the analog circuits may provide functionality that is better adjusted to the changed conditions. In some embodiments, a look-up table (LUT) 105 is associated with the DAC 104 to allow generation of waveforms with predetermined shape and timing. The AOAC 108 may program the LUT 105 based on the operating mode. The ADC post processor 118 may include a first-in-first-out (FIFO) buffer for storing result data. The AOAC 108 may instruct the ADC 116 to take samples until the FIFO is nearly full, before interrupting the CPU 122 to move the data. The number of programmable electrode interfaces 106 may vary, such as the six programmable electrode interfaces 106 illustrated in FIG. 1. More or fewer programmable electrode interfaces 106 may be provided.

In some embodiments, the control unit 108A includes a finite state machine (FSM). The FSM may be hardware-implemented as a circuit (or a set of circuits) or the FSM may be implemented as instructions executed by the control unit 108A. The control unit 108A may receive an input from the ADC 116 or the ADC post processor 118. Responsive to receiving an input, the FSM may be capable of selecting one or more FSM states that have corresponding settings in the timer table 108B for configuring the programmable electrode interfaces 106 and/or other elements of the PASS 102.

In some embodiments, the system 100 is embodied in a portable device that may perform functions to measure characteristics of a user's blood, such as continuous glucose monitoring (CGM), blood glucose monitoring (BCM), or electro-impedance spectroscopy (EIS). The system 100 may also support voice communication with the user using voice detection and speech recognition via a microphone. Other analyte measuring applications are within the scope of the present disclosure.

In some embodiments, the system 100 includes an electrochemical cell 120 interfacing with the PASS 102. The electrochemical cell 120 comprises a control electrode 122, a reference electrode 124, working electrodes 126, a guard electrode 128 for the reference electrode 124, and guard electrodes 130 for the working electrodes 126. The number of working electrodes 126 may vary, and not all of the working electrodes 126 may have associated guard electrodes 130. Other structures and/or configurations of the electrochemical cell 120 are within the scope of the present disclosure.

In some embodiments, the system 100 comprises one or more sensors 132, such as a temperature sensor, and one or more I/O devices 134 for receiving user input or providing user output, such as a microphone to support voice processing, a speaker, a keypad, a touch screen, a display, or some other I/O device. The PASS 102 may include fewer components, additional components, different components, and/or a different arrangement of components than those illustrated in FIG. 1. The PASS 102 may interface with a CPU 136 over a CPU bus 136B. The CPU 136 may receive outputs from the DAC 104, the programmable electrode interfaces 106, the AOAC 108, the comparator post processor 114, and/or the ADC post processor 118. The comparator post processor 114 and the ADC post processor 118 may be considered data processing units. In comparison to the CPU 136, the data processing units are low power computing units. In some embodiments, the PASS 102 and the CPU 136 may be provided on a single semiconductor die. The AOAC 108 operates independently and without intervention from the CPU 136 to reconfigure the programmable electrode interfaces 106.

Different configurations of the PASS 102 may have different routing fabrics defined by the routing circuitry 106R. For example, in different configurations the electrochemical cell 120 may have different numbers of working electrodes 126, guard electrodes 128 on some or all of the working electrodes 126, a guard electrode 130 for the reference electrode 124, etc. The programmable electrode interfaces 106 may be configured as an output amplifier or integrator for a working electrode 126, an amplifier or modulator for an output amplifier, a driver for a guard electrode 128, a potentiostat for the control electrode 122 and the reference electrode 124, a reference amplifier (i.e., which may operate as an amplifier, modulator, or filter) for the potentiostat.

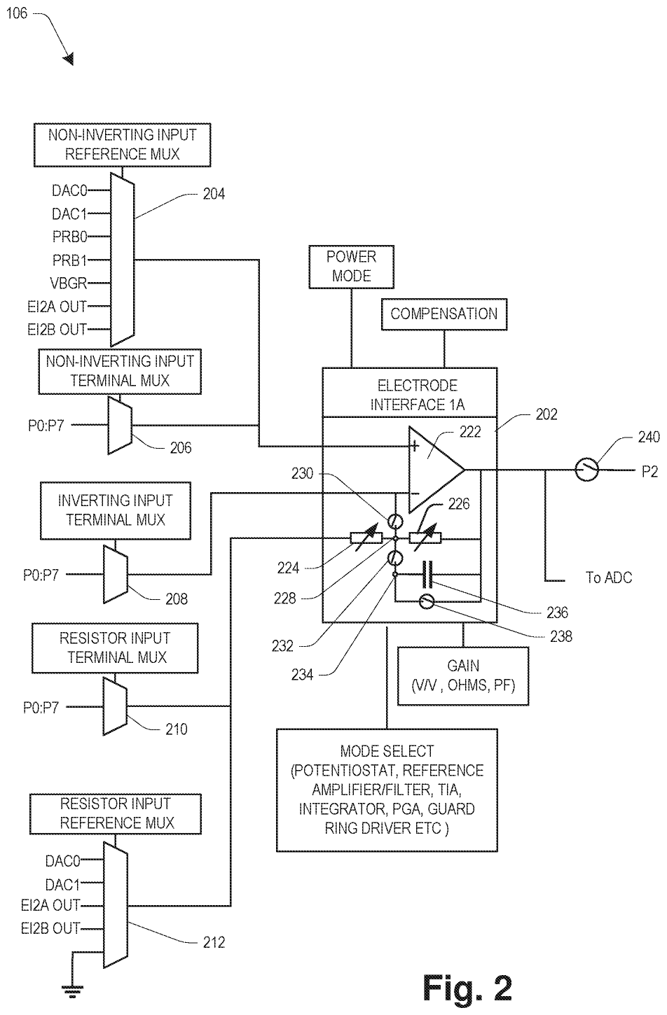

FIG. 2 is a diagram of a programmable electrode interface 106, in accordance with some embodiments. The programmable electrode interface 106 comprises an amplifier circuit 202, a non-inverting input reference multiplexer 204, a non-inverting input terminal multiplexer 206, an inverting input terminal multiplexer 208, a resistor input terminal multiplexer 210, and a resistor input reference multiplexer 212.

In some embodiments, the amplifier circuit 202 comprises an operational amplifier 222 having a non-inverting terminal (“+”), an inverting terminal (“−”), a programmable input resistor 224 connected to a programmable feedback resistor 226 at a node 228, a switch 230 connected between the node 228 and the inverting terminal, a switch 232 connected to a node 234, a capacitor 236 connected between the node 234 and an output of the operational amplifier 222, and a switch 238 connected between the node 234 and the output of the operational amplifier 222. The programmable input resistor 224 and the programmable feedback resistor 226 may be configured to have the same resistances or different resistances to affect the gain, to exhibit a short circuit, or to exhibit an open circuit. The switch 232 selectively couples the capacitor 236 or a short circuit through the switch 238 across the feedback path of the operational amplifier 222. The programmable input resistor 224, the programmable feedback resistor 226, and the switches 230, 232, 238 may be configured based on the topology or operating mode of the operational amplifier 222. The terminals connected to the programmable input resistor 224 and the programmable feedback resistor 226 may be swapped to change the gain from a positive gain to a negative gain. The configuration of the operational amplifier 222 is represented by configuration blocks that specify mode select, power mode, gain, and compensation. Compensation options include unity gain compensated, uncompensated, custom gain-based frequency compensation, etc.

The non-inverting input reference multiplexer 204 provides a selected reference signal, such as a DAC0 signal or a DAC1 signal generated by the DAC 104, a programmable reference signal, PRB0, PRB1, generated by the programmable reference unit 110, a band gap reference voltage, VBGR, or a reference generated by outputs of a different programmable electrode interface 106 (designated as EI2A OUT or EI2B OUT). The resistor input reference multiplexer 216 provides reference signals, such as DAC0, DAC1, EI2A OUT, EI2B OUT, to the input of the programmable input resistor 224. The non-inverting input terminal multiplexer 206, the inverting input terminal multiplexer 208, and the resistor input terminal multiplexer 210 connects selected terminals (P0, P7) of the PASS 102 to the non-inverting terminal of the operational amplifier 222, the inverting terminal of the operational amplifier 22, and the input of the programmable input resistor 224, respectively. The output of the operational amplifier 222 may be provided to the ADC 116 or a terminal of the PASS 102 (e.g., P2) by a switch 240.

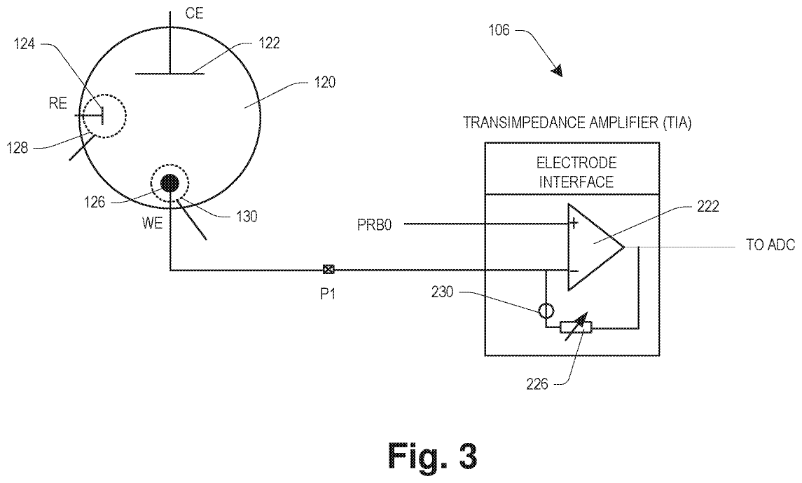

FIGS. 3-9 are diagrams of configurations for the programmable electrode interfaces 106, in accordance with some embodiments. FIG. 3 illustrates the programmable electrode interface 106 configured to operate as a transimpedance amplifier (TIA), in accordance with some embodiments. In the TIA topology, the non-inverting input reference multiplexer 204 is configured to select the PRB0 reference signal, the non-inverting input terminal multiplexer 206 is disabled, the inverting input terminal multiplexer 208 is configured to select a terminal (e.g., P1) connected to a working electrode 126, the resistor input terminal multiplexer 210 is disabled, and the resistor input reference multiplexer 212 is disabled. The switch 230 is closed, the programmable input resistor 224 is configured to provide an open circuit, the programmable feedback resistor 226 is configured with a gain resistance, and the switch 232 is open. The output of the operational amplifier 222 is routed to the ADC 116.

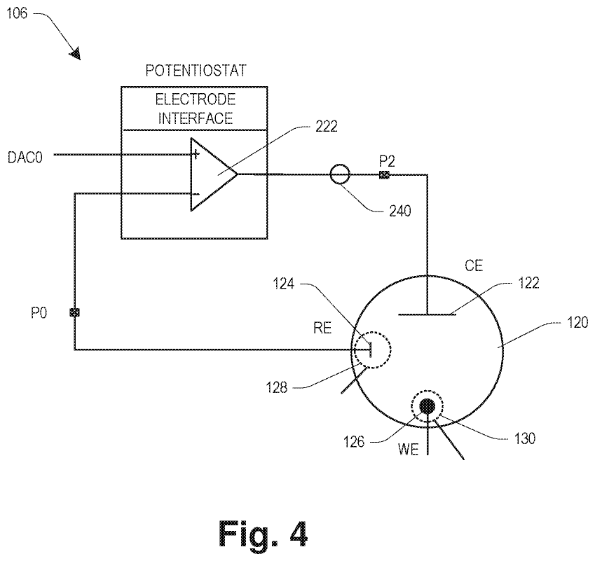

FIG. 4 illustrates the programmable electrode interface 106 configured to operate as a potentiostat, in accordance with some embodiments. In the potentiostat topology, the non-inverting input reference multiplexer 204 is configured to select the DAC0 reference signal, the non-inverting input terminal multiplexer 206 is disabled, the inverting input terminal multiplexer 208 is configured to select a terminal (e.g., P0) connected to the reference electrode 124, the resistor input terminal multiplexer 210 is disabled, and the resistor input reference multiplexer 212 is disabled. The switch 230 is open. The output of the operational amplifier 222 is routed through the switch 240 to a terminal (e.g., P2) connected to the control electrode 122.

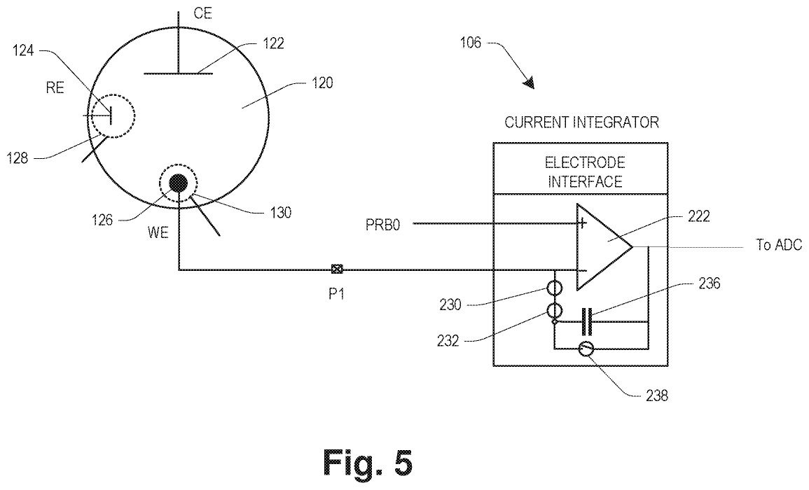

FIG. 5 illustrates the programmable electrode interface 106 configured to operate as a current integrator, in accordance with some embodiments. In the current integrator topology, the non-inverting input reference multiplexer 204 is configured to select the PRB0 reference signal, the non-inverting input terminal multiplexer 206 is disabled, the inverting input terminal multiplexer 208 is configured to select a terminal (e.g., P1) connected to a working electrode 126, the resistor input terminal multiplexer 210 is disabled, and the resistor input reference multiplexer 212 is disabled. The switches 230, 232 are closed, and the switch 238 is open to connect the capacitor 236 in the feedback path of the operational amplifier 222. The programmable input resistor 224 and the programmable feedback resistor 226 are configured to provide open circuits. The output of the operational amplifier 222 is routed to the ADC 116.

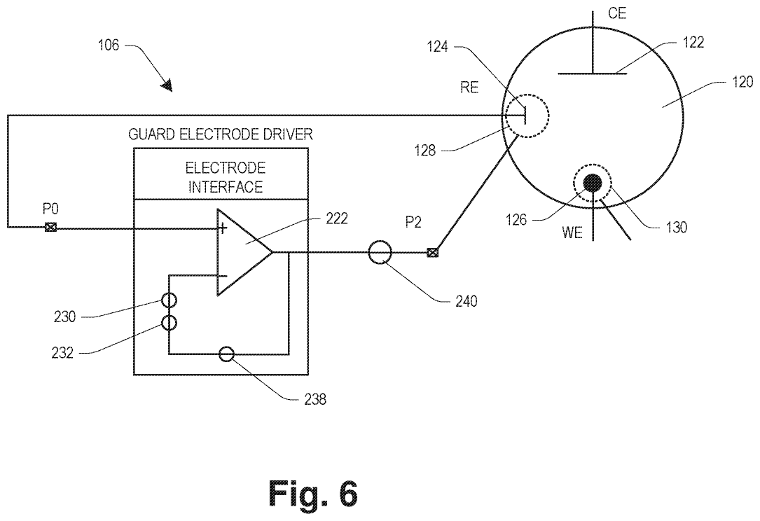

FIG. 6 illustrates the programmable electrode interface 106 configured to operate as a guard electrode driver, in accordance with some embodiments. In the guard electrode driver topology, the non-inverting input reference multiplexer 204 is disabled, the non-inverting input terminal multiplexer 206 is configured to select a terminal (e.g., P0) connected to the reference electrode 124, the inverting input terminal multiplexer 208 is disabled, the resistor input terminal multiplexer 210 is disabled, and the resistor input reference multiplexer 212 is disabled. The switches 230, 232, 238 are closed. The programmable input resistor 224 and the programmable feedback resistor 226 are configured to provide an open circuits. The output of the operational amplifier 222 is routed through the switch 240 to a terminal (e.g., P2) connected to the guard electrode 128 associated with the reference electrode 124. Alternatively, output of the operational amplifier 222 may be routed through the switch 240 to a different terminal connected to the guard electrode 130 associated a working electrode 126

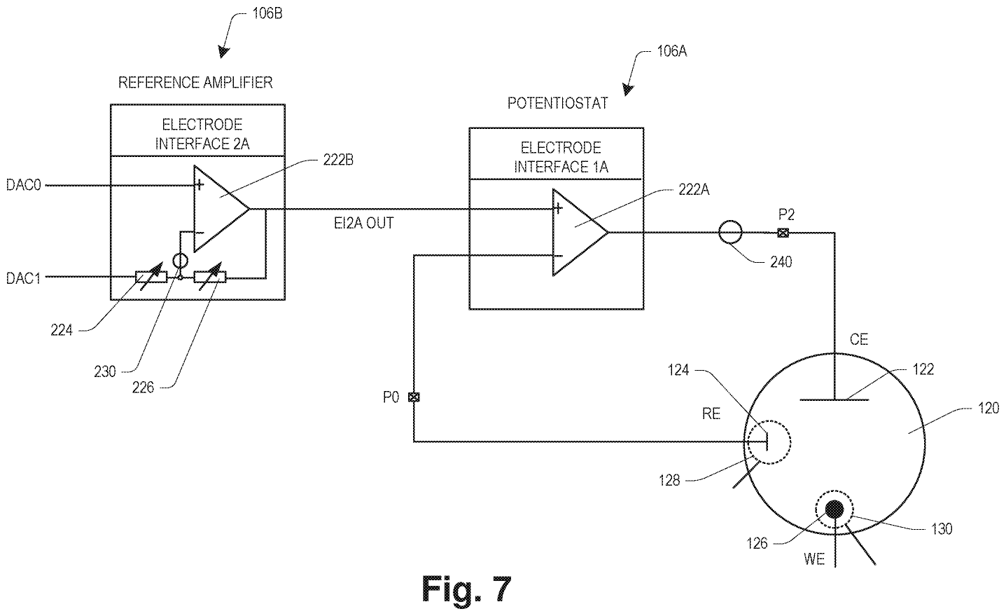

FIG. 7 illustrates a first programmable electrode interface 106A configured to operate as a potentiostat and a second programmable electrode interface 106B configured to operate as a reference amplifier, in accordance with some embodiments. For the first programmable electrode interface 106A and the operational amplifier 222A, the non-inverting input reference multiplexer 204 is configured to select the EI2A OUT reference signal, the non-inverting input terminal multiplexer 206 is disabled, the inverting input terminal multiplexer 208 is configured to select a terminal (e.g., P0) connected to the reference electrode 124, the resistor input terminal multiplexer 210 is disabled, and the resistor input reference multiplexer 212 is disabled. The switch 230 is open. The output of the operational amplifier 222 is routed through the switch 240 to a terminal (e.g., P2) connected to the control electrode 122. In the reference amplifier topology, for the second programmable electrode interface 106B and the operational amplifier 222B, the non-inverting input reference multiplexer 204 is configured to select the DAC0 reference signal, the non-inverting input terminal multiplexer 206 is disabled, the inverting input terminal multiplexer 208 is disabled, the resistor input terminal multiplexer 210 is disabled, and the resistor input reference multiplexer 212 is configured to select the DAC1 reference signal. The switch 230 is closed, the programmable input resistor 224 and the programmable feedback resistor 226 are configured to generate an amplifier gain. The output of the operational amplifier 222B is routed to the non-inverting input of the first operational amplifier 202A.

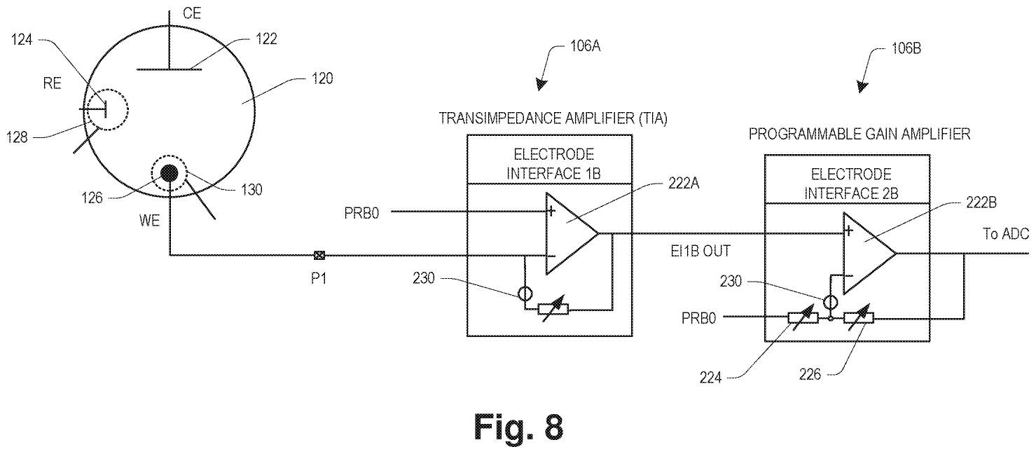

FIG. 8 illustrates a first programmable electrode interface 106A configured to operate as a TIA and a second programmable electrode interface 106B configured to operate as a programmable gain amplifier (PGA), in accordance with some embodiments. In the TIA topology, for the first programmable electrode interface 106A and the first operational amplifier 222A, the non-inverting input reference multiplexer 204 is configured to select the PRB0 reference signal, the non-inverting input terminal multiplexer 206 is disabled, the inverting input terminal multiplexer 208 is configured to select a terminal (e.g., P1) connected to a working electrode 126, the resistor input terminal multiplexer 210 is disabled, and the resistor input reference multiplexer 212 is disabled. The switch 230 is closed, the programmable input resistor 224 is configured to provide an open circuit, the programmable feedback resistor 226 is configured with a gain resistance, and the switch 232 is open. In the PGA, for the second programmable electrode interface 106B and the operational amplifier 222B, the non-inverting input reference multiplexer 204 is configured to select the EI1B OUT reference signal, the non-inverting input terminal multiplexer 206 is disabled, the inverting input terminal multiplexer 208 is disabled, the resistor input terminal multiplexer 210 is disabled, and the resistor input reference multiplexer 212 is configured to select the PRB0 reference signal. The switch 230 is closed, the programmable input resistor 224 and the programmable feedback resistor 226 are configured to generate an amplifier gain. The output of the operational amplifier 222B is routed to the ADC 116. In some embodiments, the circuit of FIG. 8 may be used with the current integrator configuration of FIG. 5. The first programmable electrode interface 106A may be configured to operate as a current integrator and the second programmable electrode interface 106B may be configured to operate as a PGA.

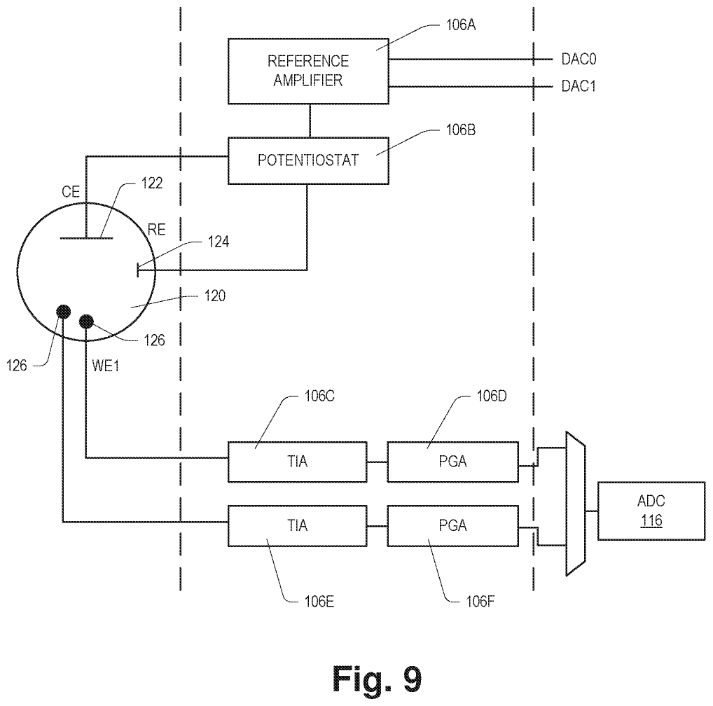

FIG. 9 illustrates the PASS 102 configured to support two working electrodes 126 in the electrochemical cell 120. No guard electrodes 128, 130 are enabled. A programmable electrode interface 106A and a programmable electrode interface 106B are configured as a reference amplifier and a potentiostat as shown in FIG. 7. A programmable electrode interface 106C and a programmable electrode interface 106D are configured to operate as a TIA and a PGA, respectively, as shown in FIG. 8. A programmable electrode interface 106E and a programmable electrode interface 106F are configured to operate as a TIA and a PGA, respectively, as shown in FIG. 8. The outputs of the programmable electrode interfaces 106D, 106F are routed to the ADC 116.

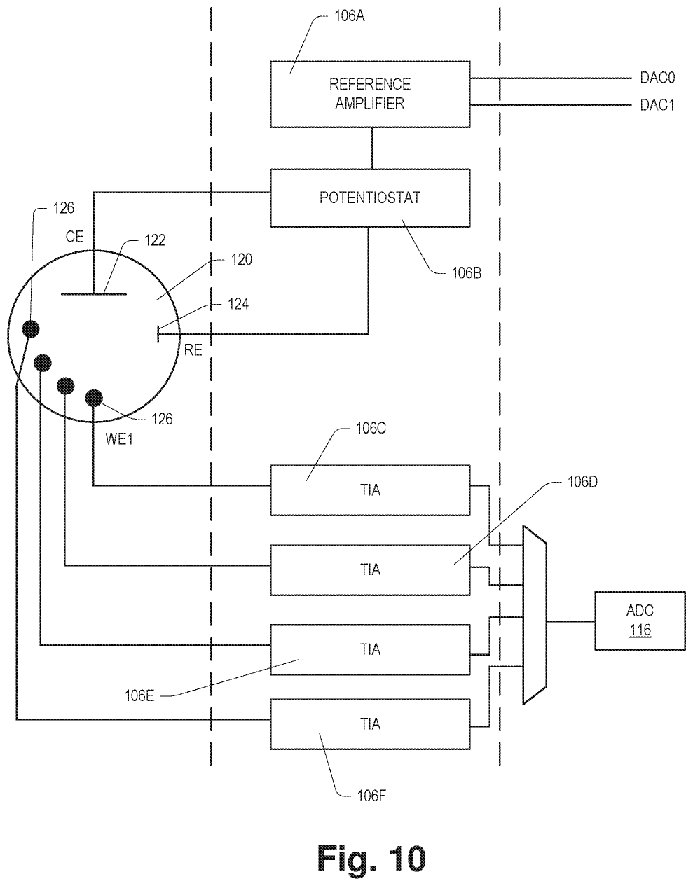

FIG. 10 illustrates the PASS 102 configured to support four working electrodes 126 in the electrochemical cell 120. No guard electrodes 128, 130 are enabled. A programmable electrode interface 106A and a programmable electrode interface 106B are configured as a reference amplifier and a potentiostat, respectively, as shown in FIG. 7. Programmable electrode interfaces 106C, 106D, 106E, 106F are configured to operate as TIAs, as shown in FIG. 3. The outputs of the programmable electrode interfaces 106C, 106D, 106E, 106F are routed to the ADC 116.

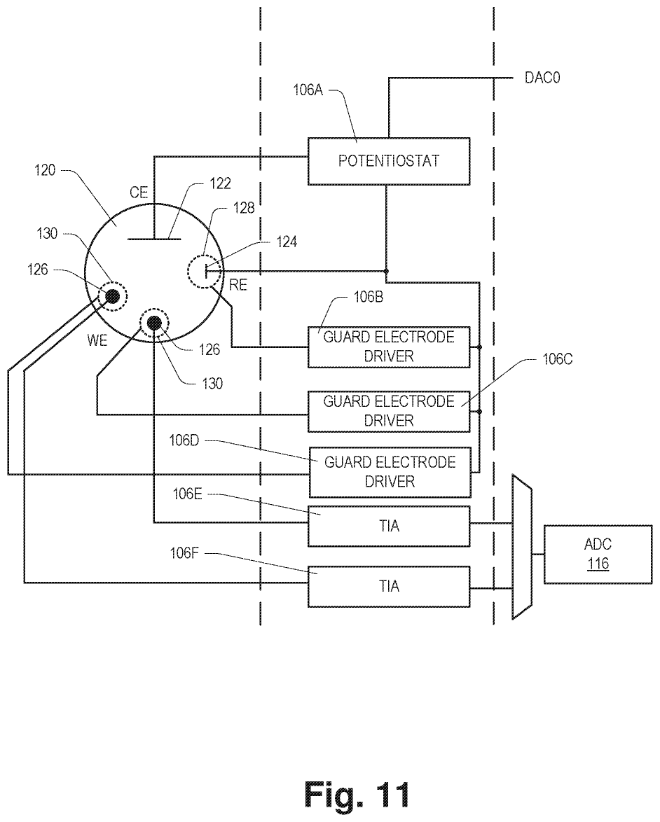

FIG. 11 illustrates the PASS 102 configured to support two working electrodes 126 in the electrochemical cell 120. Guard electrodes 128, 130 are enabled on the reference electrode 124 and the working electrodes 126, respectively. A programmable electrode interface 106A is configured as a potentiostat as shown in FIG. 4. A programmable electrode interface 106B is configured as a guard electrode driver for the guard electrode 128 associated with the reference electrode 124, as shown in FIG. 6. Programmable electrode interfaces 106C, 106D are configured as guard electrode drivers for the guard electrodes 130 associated with the working electrodes 126, similar to the arraignment shown in FIG. 6 but routed to the guard electrode 130 for the working electrode 128 as opposed to the guard electrode 128 for the reference electrode 124. Programmable electrode interfaces 106E, 106F are configured to operate as TIAs, as shown in FIG. 3. The outputs of the programmable electrode interfaces 106E, 106F are routed to the ADC 116.

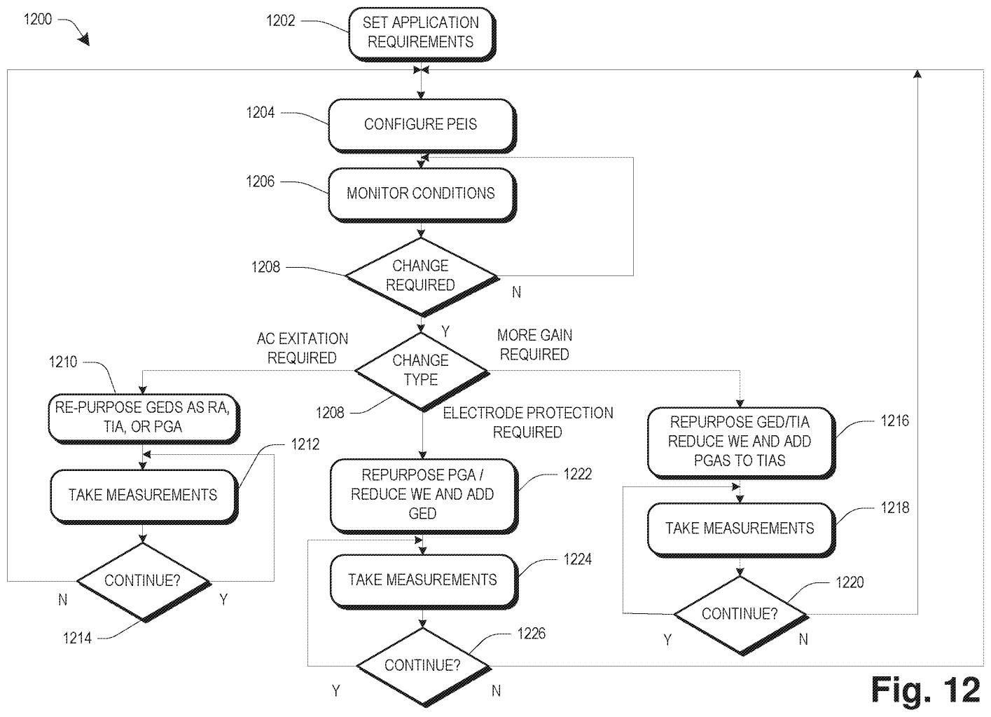

FIG. 12 is a flow chart illustrating an example method 1200 for configuring a programmable electrode interface, in accordance with some embodiments. The method 1200 may be performed by the AOAC 108. At 1202, the application requirements are set, for example, by a vendor of a device including the system 100, a user, or a default configuration. At 1204, the programmable electrode interfaces 106 are configured. For example, the initial configuration at 1202 may specify the configuration of FIG. 11. The programmable electrode interfaces 106B, 106C, 106D may be configured as guard electrode drivers for use with a DC excitation signal. At 1206, the AOAC 108 monitors conditions to determine if a change in configuration is required. In some embodiments, the AOAC 108 identifies a need for a configuration change after a predetermined time interval, such as an interval selected for changing between DC excitation and AC excitation. In some embodiments, the AOAC 108 identifies a need for a configuration change based on a signal level, such as the signal provided to the ADC 116.

At 1208, the AOAC 108 determines the type of change to be implemented. For example, if the AOAC 108 changes the configuration to support AC excitation at 1208, the programmable electrode interfaces 106B, 106C, 106D configured as guard electrode drivers may be repurposed at 1210 to operate as a reference amplifier, TIAs, or PGAs, such as illustrated in FIG. 9 or FIG. 10. For example, to transition from the configuration of FIG. 11 to the configuration of FIG. 9, two of the guard electrode drivers are reconfigured as PGAs and one of the electrode drivers is reconfigured as a reference amplifier. To transition from the configuration of FIG. 11 to the configuration of FIG. 10, two of the guard electrode drivers are reconfigured as TIAs and one of the electrode drivers is reconfigured as a reference amplifier. Measurements are collected using the modified configuration at 1212 until a condition is met at 1214, such as after a predetermined time interval or after a predetermined number of measurements. After measurement is concluded at 1214, the method 1200 returns to 1204 to reconfigure if necessary. If at 1208, the AOAC 108 determines the type of change to be implemented requires additional gain, such as responsive to the signal provided to the ADC 116 being less than a predetermined threshold, at 1216, the AOAC reconfigures guard electrode drivers or TIAs to operate as a reference amplifier or PGAs. For example, to transition from the configuration of FIG. 11 to the configuration of FIG. 9, two of the guard electrode drivers are reconfigured as PGAs and one of the electrode drivers is reconfigured as a reference amplifier. To transition from the configuration of FIG. 10 to the configuration of FIG. 9, two of the TIAs are reconfigured as PGAs and the number of working electrodes 126 is reduced. Measurements are collected using the modified configuration at 1218 until a condition is met at 1220, such as after a predetermined time interval or after a predetermined number of measurements. After measurement is concluded at 1220, the method 1200 returns to 1204 to reconfigure if necessary.

If at 1208, the AOAC 108 determines the type of change to be implemented requires guard electrode drivers, such as responsive to changing from AC excitation to DC excitation, at 1222, the AOAC reconfigures PGAs, the reference amplifier, or TIAs to operate as guard electrode drivers. For example, to transition from the configuration of FIG. 9 to the configuration of FIG. 11, the PGAs and the reference amplifier are reconfigured as guard electrode drivers. To transition from the configuration of FIG. 10 to the configuration of FIG. 11, two of the TIAs and the reference amplifier are reconfigured as guard electrode drivers. Measurements are collected using the modified configuration at 1224 until a condition is met at 1226, such as after a predetermined time interval or after a predetermined number of measurements. After measurement is concluded at 1226, the method 1200 returns to 1204 to reconfigure if necessary.

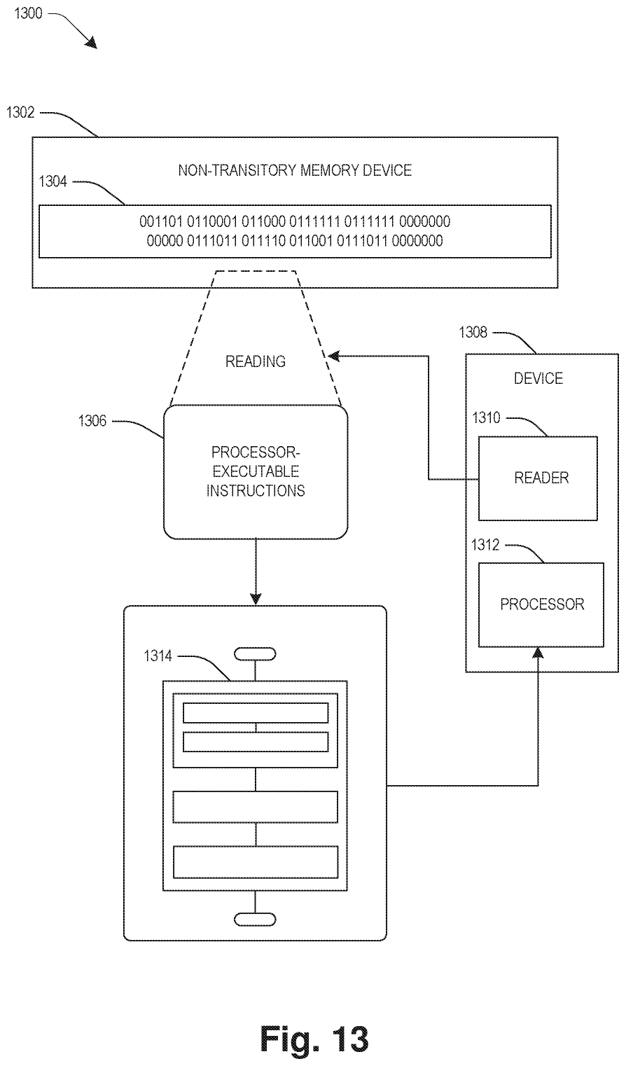

FIG. 13 illustrates an exemplary embodiment 1300 of a computer-readable medium 1302, in accordance with some embodiments. One or more embodiments involve a computer-readable medium comprising processor-executable instructions configured to implement one or more of the techniques presented herein. The embodiment 1300 comprises a non-transitory computer-readable medium 1302 (e.g., a CD-R, DVD-R, flash drive, a platter of a hard disk drive, etc.), on which is encoded computer-readable data 1304. This computer-readable data 1304 in turn comprises a set of processor-executable computer instructions 1306 that, when executed by a computing device 1308 including a reader 1310 for reading the processor-executable computer instructions 1306 and a processor 1312 for executing the processor-executable computer instructions 1306, are configured to facilitate operations according to one or more of the principles set forth herein. In some embodiments, the processor-executable computer instructions 1306, when executed, are configured to facilitate performance of a method 1314, such as at least some of the aforementioned method(s). In some embodiments, the processor-executable computer instructions 1306, when executed, are configured to facilitate implementation of a system, such as at least some of the one or more aforementioned system(s). Many such computer-readable media may be devised by those of ordinary skill in the art that are configured to operate in accordance with the techniques presented herein.

The term “computer readable media” and/or the like may include communication media. Communication media typically embodies computer readable instructions or other data in a “modulated data signal” such as a carrier wafer or other transport mechanism and includes any information delivery media. The term “modulated data signal” may include a signal that has one or more of its characteristics set or changed in such a manner as to encode information in the signal.

In an embodiment of the techniques presented herein, a sensor is provided. The sensor comprises an electrochemical cell comprising a first working electrode, a second working electrode, and a first guard electrode adjacent the first working electrode, and a programmable analog subsystem. The programmable analog subsystem comprises a first programmable electrode interface, and a second programmable electrode interface, wherein in a first configuration, the first programmable electrode interface is connected to the first working electrode and the second programmable electrode interface is connected to one of the first programmable electrode interface or the second working electrode, and in a second configuration, the first programmable electrode interface is connected to the first working electrode and the second programmable electrode interface is connected to the first guard electrode.

In an embodiment of the techniques presented herein, in the first configuration, the first programmable electrode interface is configured in a transimpedance amplifier configuration and the second programmable electrode interface is configured in a programmable gain amplifier configuration if connected to the first programmable electrode interface or the second programmable electrode interface is configured in the transimpedance amplifier configuration if connected to the second working electrode, and in the second configuration, the first programmable electrode interface is configured in the transimpedance amplifier configuration and the second programmable electrode interface is configured in a guard electrode driver configuration.

In an embodiment of the techniques presented herein, the programmable analog subsystem comprises a third programmable electrode interface configured in a programmable gain amplifier configuration with an input connected to an output of the first programmable electrode interface.

In an embodiment of the techniques presented herein, the electrochemical cell comprises a third working electrode, and a fourth working electrode, and the programmable analog subsystem comprises a third programmable electrode interface configured in the first configuration in the transimpedance amplifier configuration and connected to the third working electrode, and a fourth programmable electrode interface configured in the first configuration in the transimpedance amplifier configuration and connected to the fourth working electrode.

In an embodiment of the techniques presented herein, the electrochemical cell comprises a reference electrode, and a control electrode, and the programmable analog subsystem comprises a third programmable electrode interface configured in a potentiostat configuration and connected to the reference electrode and the control electrode.

In an embodiment of the techniques presented herein, the programmable analog subsystem comprises a digital-to-analog converter configured to generate a first reference signal and a second reference signal, and a fourth programmable electrode interface configured in a reference amplifier configuration having a first input connected to receive the first reference signal, a second input connected to receive the second reference signal, and an output connected to the third programmable electrode interface.

In an embodiment of the techniques presented herein, the programmable analog subsystem comprises a fifth programmable electrode interface configured in the first configuration in a programmable gain amplifier configuration and connected to the first programmable electrode interface, and a sixth programmable electrode interface configured in the first configuration in the programmable gain amplifier configuration and connected to the second programmable electrode interface.

In an embodiment of the techniques presented herein, the electrochemical cell comprises a reference electrode, and a guard electrode adjacent the reference electrode, and the programmable analog subsystem comprises a third programmable electrode interface configured in the second configuration in a guard electrode driver configuration and connected to the reference electrode.

In an embodiment of the techniques presented herein, the electrochemical cell comprises a control electrode, and the programmable analog subsystem comprises a fourth programmable electrode interface configured in a potentiostat configuration and connected to the reference electrode and the control electrode.

In an embodiment of the techniques presented herein, the programmable analog subsystem comprises a controller configured to change the programmable analog subsystem from the first configuration to the second configuration based on one of a predetermined time interval or based on a signal generated by one of the first programmable electrode interface or the second programmable electrode interface.

In an embodiment of the techniques presented herein, a sensor is provided. The sensor comprises an electrochemical cell comprising a first working electrode, a control electrode, a reference electrode, and a guard electrode adjacent one of the first working electrode or the guard electrode, and a programmable analog subsystem. The programmable analog subsystem comprises a first programmable electrode interface, and a controller configured to connect the first programmable electrode interface to one of the first working electrode, the control electrode, the reference electrode, or the guard electrode in a first configuration and to connect the first programmable electrode interface to a different one of the first working electrode, the control electrode, the reference electrode, or the guard electrode in a second configuration.

In an embodiment of the techniques presented herein, the programmable analog subsystem comprises a second programmable electrode interface, the first programmable electrode interface is configured in a transimpedance amplifier configuration, and the second programmable electrode interface is configured in a programmable gain amplifier configuration with an input connected to an output of the first programmable electrode interface.

In an embodiment of the techniques presented herein, the programmable analog subsystem comprises a second programmable electrode interface, the first programmable electrode interface is connected to one of the reference electrode or the first working electrode, and the second programmable electrode interface is connected to the guard electrode and configured in a guard electrode driver configuration.

In an embodiment of the techniques presented herein, the programmable analog subsystem comprises a third programmable electrode interface configured in a potentiostat configuration and connected to the reference electrode and the control electrode.

In an embodiment of the techniques presented herein, the programmable analog subsystem comprises a digital-to-analog converter configured to generate a first reference signal and a second reference signal, and a fourth programmable electrode interface configured in a reference amplifier configuration having a first input connected to receive the first reference signal, a second input connected to receive the second reference signal, and an output connected to the third programmable electrode interface.

In an embodiment of the techniques presented herein, the programmable analog subsystem comprises a second programmable electrode interface, and the first programmable electrode interface comprises an operational amplifier having a non-inverting input and an inverting input, a first multiplexer configured to selectively connect one of the first working electrode, the control electrode, the reference electrode, or the guard electrode to the non-inverting input, a second multiplexer configured to selectively connect one of the first working electrode, the control electrode, the reference electrode, or the guard electrode to the inverting input, and a third multiplexer configured to selectively connect one of a reference signal or an output of the second programmable electrode interface to the non-inverting input.

In an embodiment of the techniques presented herein, a method is provided. The method comprises connecting a first programmable electrode interface to one of a first working electrode, a control electrode, a reference electrode, or a guard electrode of an electrochemical cell in a first configuration, and connecting the first programmable electrode interface to a different one of the first working electrode, the control electrode, the reference electrode, or the guard electrode in a second configuration.

In an embodiment of the techniques presented herein, the method comprises configuring the first programmable electrode interface in a transimpedance amplifier configuration, and configuring a second programmable electrode interface in a programmable gain amplifier configuration with an input connected to an output of the first programmable electrode interface.

In an embodiment of the techniques presented herein, the first programmable electrode interface is connected to one of the reference electrode or the first working electrode, and the method comprises connecting a second programmable electrode interface configured in a guard electrode driver configuration to the guard electrode.

In an embodiment of the techniques presented herein, the method comprises connecting a third programmable electrode interface configured in a potentiostat configuration to the reference electrode and the control electrode, and connecting a fourth programmable electrode interface configured in a reference amplifier configuration to the third programmable electrode interface, wherein the fourth programmable electrode interface comprises a first input connected to a digital-to-analog converter to receive a first reference signal, a second input connected to the digital-to-analog converter to receive a second reference signal, and an output connected to the third programmable electrode interface.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A sensor, comprising:
an electrochemical cell comprising:
a first working electrode;
a second working electrode; and
a first guard electrode adjacent the first working electrode; and
a programmable analog subsystem, comprising:
a first programmable electrode interface; and
a second programmable electrode interface, wherein:
in a first configuration, the first programmable electrode interface is connected to the first working electrode and the second programmable electrode interface is connected to one of the first programmable electrode interface or the second working electrode, and
in a second configuration, the first programmable electrode interface is connected to the first working electrode and the second programmable electrode interface is connected to the first guard electrode.

2. The sensor of claim 1, wherein:
in the first configuration, the first programmable electrode interface is configured in a transimpedance amplifier configuration and the second programmable electrode interface is configured in a programmable gain amplifier configuration if connected to the first programmable electrode interface or the second programmable electrode interface is configured in the transimpedance amplifier configuration if connected to the second working electrode, and
in the second configuration, the first programmable electrode interface is configured in the transimpedance amplifier configuration and the second programmable electrode interface is configured in a guard electrode driver configuration.

3. The sensor of claim 1, wherein:
the programmable analog subsystem comprises:
a third programmable electrode interface configured in a programmable gain amplifier configuration with an input connected to an output of the first programmable electrode interface.

4. The sensor of claim 2, wherein:
the electrochemical cell comprises:
a third working electrode; and
a fourth working electrode, and
the programmable analog subsystem comprises:
a third programmable electrode interface configured in the first configuration in the transimpedance amplifier configuration and connected to the third working electrode; and
a fourth programmable electrode interface configured in the first configuration in the transimpedance amplifier configuration and connected to the fourth working electrode.

5. The sensor of claim 1, wherein:
the electrochemical cell comprises:
a reference electrode; and
a control electrode, and
the programmable analog subsystem comprises:
a third programmable electrode interface configured in a potentiostat configuration and connected to the reference electrode and the control electrode.

6. The sensor of claim 5, wherein:
the programmable analog subsystem comprises:
a digital-to-analog converter configured to generate a first reference signal and a second reference signal; and
a fourth programmable electrode interface configured in a reference amplifier configuration having a first input connected to receive the first reference signal, a second input connected to receive the second reference signal, and an output connected to the third programmable electrode interface.

7. The sensor of claim 6, wherein:
the programmable analog subsystem comprises:
a fifth programmable electrode interface configured in the first configuration in a programmable gain amplifier configuration and connected to the first programmable electrode interface; and
a sixth programmable electrode interface configured in the first configuration in the programmable gain amplifier configuration and connected to the second programmable electrode interface.

8. The sensor of claim 1, wherein:
the electrochemical cell comprises:
a reference electrode; and
a guard electrode adjacent the reference electrode, and
the programmable analog subsystem comprises:
a third programmable electrode interface configured in the second configuration in a guard electrode driver configuration and connected to the reference electrode.

9. The sensor of claim 8, wherein:
the electrochemical cell comprises:
a control electrode, and
the programmable analog subsystem comprises:
a fourth programmable electrode interface configured in a potentiostat configuration and connected to the reference electrode and the control electrode.

10. The sensor of claim 1, wherein:
the programmable analog subsystem comprises:
a controller configured to change the programmable analog subsystem from the first configuration to the second configuration based on one of a predetermined time interval or based on a signal generated by one of the first programmable electrode interface or the second programmable electrode interface.

11. A sensor, comprising:
an electrochemical cell comprising:
a first working electrode;
a control electrode;
a reference electrode; and
a guard electrode adjacent one of the first working electrode or the guard electrode; and
a programmable analog subsystem, comprising:
a first programmable electrode interface; and
a controller configured to connect the first programmable electrode interface to one of the first working electrode, the control electrode, the reference electrode, or the guard electrode in a first configuration and to connect the first programmable electrode interface to a different one of the first working electrode, the control electrode, the reference electrode, or the guard electrode in a second configuration.

12. The sensor of claim 11, wherein:
the programmable analog subsystem comprises a second programmable electrode interface,
the first programmable electrode interface is configured in a transimpedance amplifier configuration, and
the second programmable electrode interface is configured in a programmable gain amplifier configuration with an input connected to an output of the first programmable electrode interface.

13. The sensor of claim 11, wherein:
the programmable analog subsystem comprises a second programmable electrode interface,
the first programmable electrode interface is connected to one of the reference electrode or the first working electrode, and
the second programmable electrode interface is connected to the guard electrode and configured in a guard electrode driver configuration.

14. The sensor of claim 13, wherein:
the programmable analog subsystem comprises:
a third programmable electrode interface configured in a potentiostat configuration and connected to the reference electrode and the control electrode.

15. The sensor of claim 14, wherein:
the programmable analog subsystem comprises:
a digital-to-analog converter configured to generate a first reference signal and a second reference signal; and
a fourth programmable electrode interface configured in a reference amplifier configuration having a first input connected to receive the first reference signal, a second input connected to receive the second reference signal, and an output connected to the third programmable electrode interface.

16. The sensor of claim 11, wherein:
the programmable analog subsystem comprises a second programmable electrode interface, and
the first programmable electrode interface comprises:
an operational amplifier having a non-inverting input and an inverting input;
a first multiplexer configured to selectively connect one of the first working electrode, the control electrode, the reference electrode, or the guard electrode to the non-inverting input;
a second multiplexer configured to selectively connect one of the first working electrode, the control electrode, the reference electrode, or the guard electrode to the inverting input; and
a third multiplexer configured to selectively connect one of a reference signal or an output of the second programmable electrode interface to the non-inverting input.

17. A method, comprising:
connecting a first programmable electrode interface to one of a first working electrode, a control electrode, a reference electrode, or a guard electrode of an electrochemical cell in a first configuration; and
connecting the first programmable electrode interface to a different one of the first working electrode, the control electrode, the reference electrode, or the guard electrode in a second configuration.

18. The method of claim 17, comprising:
configuring the first programmable electrode interface in a transimpedance amplifier configuration; and
configuring a second programmable electrode interface in a programmable gain amplifier configuration with an input connected to an output of the first programmable electrode interface.

19. The method of claim 17, wherein:
the first programmable electrode interface is connected to one of the reference electrode or the first working electrode, and
the method comprises connecting a second programmable electrode interface configured in a guard electrode driver configuration to the guard electrode.

20. The method of claim 19, comprising:
connecting a third programmable electrode interface configured in a potentiostat configuration to the reference electrode and the control electrode; and
connecting a fourth programmable electrode interface configured in a reference amplifier configuration to the third programmable electrode interface, wherein:
the fourth programmable electrode interface comprises:
a first input connected to a digital-to-analog converter to receive a first reference signal;
a second input connected to the digital-to-analog converter to receive a second reference signal; and
an output connected to the third programmable electrode interface.
